(19) United States
(12) Patent Application Publication
(10) Pub. No.: US 2013/0304564 A1
(43) Pub. Date: Nov. 14, 2013

(54) METHOD OF PROVIDING ACCESS MANAGEMENT IN AN ELECTRONIC APPARATUS

(71) Applicant: Clair F. Wheeler, Cypress, TX (US)

(72) Inventor: Clair F. Wheeler, Cypress, TX (US)

(21) Appl. No.: 13/910,534

(22) Filed: Jun. 5, 2013

Related U.S. Application Data
(62) Division of application No. 12/973,770, filed on Dec. 20, 2010.

(51) Int. Cl. G06Q 50/20; G06Q 30/02

(52) U.S. Cl. CPC G06Q 50/20; G06Q 30/0236
USPC 705/14.36

(57) ABSTRACT

In one embodiment of the present invention, a method for providing reward management for an apparatus is provided. The method includes linking a reward manager to an application residing on the apparatus; providing the reward manager with a reward account which accumulates reward opportunities and reward credits; and crediting the reward account only after a reward opportunity is satisfied, wherein the user is uses reward opportunities or reward credits to gain access to the application. The credits in the reward account may be used for commercial transaction. The credits in the reward account may be used to obtain the rights to a predetermined number of one or more of the following: text messages, telephone talking time, music time, video time, camera access, or video game time. The set of reward opportunities may comprise one or more questions, and wherein the reward opportunities are satisfied when the questions are answered correctly.

### CROSS REFERENCE TO RELATED APPLICATIONS

This is a divisional application of U.S. Nonprovisional Application No. 12/973,770, filed Dec. 20, 2010, the entire contents of which are incorporated herein by reference.

### BACKGROUND

Advances in electronics technologies have had a significant impact on the lives of everyone in the world. From simple telephony to texting, modern electronic technologies have allowed everyone to more easily communicate with one another regardless of geographic limitations. From simple mp3 players to smart phones, electronic technologies have also allowed everyone access to a vast selection of entertainment choices regardless of location. The Internet hails as the one of the most significant advances that has had a substantial influence on everyone's daily routines.

Evidence of this impact can be seen in the insatiable appetites for e-mail communications and Internet services, such as, the World Wide Web (WWW), instant messaging, online discussion boards (chat rooms), etc. The impact of the Internet and other similar communications networks can be seen both at home and in the workplace.

Educators and parents are finding it more difficult to ensure that students are taking the time to study. Students have access to many types of electronic equipment that allow them unsupervised diversions. For example, students can logon to Internet chat sessions; play electronic video games on desktop computers, hand-held devices, or television sets; download and play music and videos from the Internet; watch a television program or a DVD video; or surf the World Wide Web. When a student is using a computer, watching a television set, or playing a video game, a parent can never be sure that the child is doing something educational.

The present invention proposes a solution to this problem.

### SUMMARY

In one embodiment of the present invention, a method for providing reward management for an apparatus is provided. The method includes linking a reward manager to an application residing on the apparatus; providing the reward manager with a reward account, wherein the reward account accumulates reward opportunities and reward credits; and crediting the reward account only after a reward opportunity is satisfied, wherein the user is uses reward opportunities or reward credits to gain access to the application.

In one embodiment of the present invention, the credits in the reward account may be used for commercial transaction. The credits in the reward account may be used to obtain the rights to a predetermined number of one or more of the following: text messages, telephone talking time, music time, video time, camera access, or video game time. The credits in the reward account may be accumulated and are displayed on the apparatus.

In one embodiment of the present invention, the set of reward opportunities may comprise one or more questions, and wherein said reward opportunities are satisfied when the questions are answered correctly. The set of reward opportunities may comprise a predetermined number of correctly answered questions or a predetermined ratio of correctly answered questions and/or predetermined number of correctly answered questions completed in a predetermined length of time. The questions may represent a variable amount to be credited.

### DESCRIPTION OF PREFERRED EMBODIMENTS

Embodiments of the present invention are directed to a method for providing access management, or reward management in an apparatus. A user, generally a student, will be required to complete a predetermined set of access permissions, or reward opportunities, before the user may gain access to the desired application or host system. Typically, the user will be a school-age child. The access permissions require the user to perform tasks that demonstrate their growing mastery of a given subject matter. These tasks can include requiring a user to answer questions on a variety of topics, or to perform timed readings, analytical computations, and other tasks that help him memorize and learn materials.

The host system can be almost any kind of electronic equipment, including, but not limited to, a pager, a mobile phone, a feature phone, a smart phone, an electronic organizer, a personal digital assistant, a net book, a tablet computer, a notebook computer, a personal computer, a portable media player, a Wi-Fi mobile platform, an electronic game, a video game, a television, a camera, or any other system upon which a user can be required to perform access permissions.

The applications can be virtually any type of program or operating system that is compatible with any of the above host system, including, but not limited to, a social network, a game, a video, a video site, a search engine, a mobile application, music, a music site, a television program, a movie or any other application capable of being accessed on a host system.

The access system may be application specific, wherein the user may require specific credits for specific host systems or applications. The access system may also be application non-specific, wherein the user may

In operation, when the user wishes to utilize an electronic application or host system, they must first perform a predetermined set of access permissions, or reward opportunities before the user application or host system is authorized. In this way, the user is forced to perform an access permission before he is allowed to enjoy the user application or host system.

The access permissions, or reward opportunities, may be, for example, that the user answer a question correctly; meet a minimum performance criteria, such as correctly answering a specified number of questions based on a prior reading (i.e., a reading comprehension test; reading at least a pre-determined number of words within a predetermined time; or completing at least a minimum number of access permissions from a selected number of access permissions).

Once permission is granted, in one embodiment the user application or host system may be discontinued after a predetermined period of time, thereby requiring additional access permissions, or reward opportunities, to continue. The frequency of the interrupts can be wholly or partly dependent on a user's performance on past access permissions, reward opportunities or education tasks.

In one embodiment, a testing system includes an access manager, or reward manager, and data used by the access manager, such as a database and one or more configuration files. The access manager, may present tests that require the user to answer one or more questions presented; these may be drills that require the user, for example, to read presented text within a given time limit and possibly answer questions related to the text; or it can present other tests, drills, or tasks, either timed or not timed, that help a user learn material.

The access manager presents the user with the access permissions, receives the user's responses, and informs the user whether he has submitted a correct or an incorrect answer. The access manager lets a parent, guardian, or teacher (a testing administrator) set parameters stored in configuration files used to configure the testing system (reward and management system). These configuration files may set the time intervals during which the user is presented with access permissions, or it may set the types of access permissions that the user is presented with, including the topics and difficulty level of the access permissions.

In this way, the access manager can devise a lesson plan that the user must follow. This is helpful, for example, when the parent determines that the user should concentrate on specific subjects having a specific difficulty level.

The access permissions or reward opportunities comprise the challenges that the user is presented. The access permissions or reward opportunities may be sets of questions and corresponding correct answers (question and answer pairs) on a variety of topics; it may contain text used in timed readings; and it may contain other information used to test a user's knowledge. The access permissions may be edited by the parent to add, delete, or modify question and answer pairs or other information useful to the user.

In one embodiment, if the user's response does not match the correct answer, the user is given another opportunity to submit an answer. The access manager will not grant the user permission to use the application or host system until the user has submitted a correct answer, a series of correct answers or has a sufficient account balance or accumulative credits in the user's reward credit account based on previous correctly answered access permissions or reward opportunities.

The testing system or access manager can also provide the parent with information about a user's performance. For example, it can provide a test score giving the percentage of access permissions or reward opportunities that the user performed correctly. The parent can use these test scores and other information to gauge how well a user is learning educational materials.

In one embodiment, the access manager, or reward manager, may not be deactivated or removed, except by the parent or testing administrator. The parent or testing administrator has other privileges not granted to the user. For example, the testing administrator may use a pass code to bypass the access manager so that the application and apparatus are returned to the user even if an access permission is not performed. This privilege is denied to the user, who must satisfy the access permissions before being returned to the user application.

In one embodiment of the present invention, a method of providing access management in an apparatus is disclosed. The apparatus includes a host system or platform for running an application; an access manager for handling access of a user to the application; and a set of access permissions stored in the apparatus and used by the access manager for controlling access of the user to applications. The method includes linking the entry permissions to the application or host system, and allowing the user access to the application only after predetermined access permissions are satisfied.

The apparatus may be a pager, a mobile phone, a feature phone, or a smart phone. The apparatus may be an electronic organizer, a personal digital assistant, net book, a tablet computer, or a personal computer. The apparatus may be a portable media player, a Wi-Fi mobile platform, an electronic game, a television or a camera.

In one embodiment, the set of access permissions may include one or more questions that must be answered correctly. The set of access permissions may include a predetermined number of correctly answered questions, a predetermined ratio of correctly answered questions and/or a predetermined number of correctly answered questions completed in a predetermined length of time. The set of access permissions may include a predetermined time since the last series of questions was asked. The questions may be selected to assist in the learning of an academic subject. The questions may be selected to assist in preparing the user for a standardized test.

In one embodiment of the method, the access manager may be remotely added, administered, monitored and/or controlled. The access manager may be locally added, administered, monitored and/or controlled on the apparatus by means of an administrative (parental) password access. The remote monitoring may include compiling historical trends. The remote controlling may include selecting the subject matter of the questions, the specific questions that are available, the time allowed for answering questions and/or the variable credit to be associated with each question.

In another embodiment, the apparatus may bypass the access manager providing the user access to emergency telephone numbers at all times. The apparatus may bypass the access manager providing the user emergency access at all times. The apparatus may bypass the access manager providing the user access to pre-selected telephone numbers at all times. The apparatus may bypass the access manager providing the user pre-selected access at all times

In another embodiment of the present invention, a method of providing reward management by means of an apparatus is disclosed. The apparatus may include a platform for running an application; a reward manager maintaining a reward account for the user; and a set of reward opportunities stored in the apparatus and used by the reward manager to provide incentives to the user. The method may include linking the reward opportunities to the application, and crediting the reward account only after a reward opportunity is satisfied.

The method may require that the credits in the reward account may be used for commercial transaction. The access manager or reward manager may accumulate credits in the reward account for future use. The credits in the reward account may be used to obtain the rights to a predetermined number of one or more of the following: text messages, telephone talking time, music time, video time, camera access, or video game time. The credits in the reward account may be displayed on the apparatus.

In another embodiment the set of reward opportunities may include one or more questions, and wherein said reward opportunities are satisfied when the questions are answered correctly. The set of reward opportunities may include a predetermined ratio of correctly answered questions. The questions may represent a variable amount to be credited.

In another embodiment of the present invention, a method for providing reward management for an apparatus is disclosed. The method may include linking a reward manager to an application residing on the apparatus, providing the reward manager with a reward account, wherein the reward account accumulates reward opportunities, plus reward credits and crediting the reward account only after a reward opportunity is satisfied.

In another embodiment, the credits in the reward account may be used for commercial transaction. The credits in the reward account may be used to obtain the rights to a predetermined number of one or more of the following: text messages, telephone talking time, music time, video time, television camera access, or video game time. The credits in the reward account may accumulate and the accumulated amount of credits may be displayed on the apparatus. The set of reward opportunities may include one or more questions, and wherein said reward opportunities are satisfied when the questions are answered correctly. The set of reward opportunities may include a predetermined ratio of correctly answered questions. The questions may represent a variable amount to be credited.

What is claimed is:

1. A method for providing reward management for an apparatus, the method comprising:
linking a reward manager to an application residing on the apparatus,
providing the reward manager with a reward account, wherein the reward account accumulates reward opportunities and reward credits,
crediting the reward account only after a reward opportunity is satisfied, wherein the user is uses reward opportunities or reward credits to gain access to the application.

2. The method of claim 1, wherein the credits in the reward account are used for commercial transaction.

3. The method of claim 1, wherein the credits in the reward account are used to obtain the rights to a predetermined number of one or more of the following: text messages, telephone talking time, music time, video time, camera access, or video game time.

4. The method of claim 1, wherein the credits in the reward account may be accumulated and are displayed on the apparatus.

5. The method of claim 1, wherein the set of reward opportunities comprises one or more questions, and wherein said reward opportunities are satisfied when the questions are answered correctly.

6. The method of claim 1, wherein the set of reward opportunities comprises a predetermined number of correctly answered questions or a predetermined ratio of correctly answered questions and/or predetermined number of correctly answered questions completed in a predetermined length of time.

7. The method of claim 6, wherein the questions represents a variable amount to be credited.
